(19) United States
(12) Patent Application Publication
(10) Pub. No.: US 2016/0010628 A1
(43) Pub. Date: Jan. 14, 2016

(54) SYSTEM AND METHOD FOR DETERMINING LIFE OF A WIND TURBINE

(71) Applicant: General Electric Company, Schenectady, NY (US)

(72) Inventors: Sandeep DHAR, Bangalore (IN); Pameet SINGH, Bangalore (IN)

(21) Appl. No.: 14/791,907

(22) Filed: Jul. 6, 2015

(30) Foreign Application Priority Data
Jul. 10, 2014 (IN) 3433/CHE/2014

(51) Int. Cl. F03D 11/00

(52) U.S. Cl. CPC F03D 11/0091

(57) ABSTRACT

A method implemented using at least one processor module includes receiving turbine data of a wind turbine having s a plurality of persistent failure modes. The turbine data comprises installation data, operation data and historical data. The method also includes determining a plurality of damage values using a plurality of damage models based on the installation data and determining a plurality of correction values based on the operation data, and the historical data. The plurality of damage values are representative of severity of the plurality of persistent failure modes and the plurality of correction values are representative of severity of a plurality of sporadic failure modes. The method also includes determining a plurality of corrected damage values by modifying the plurality of damage values based on at least one of the plurality of correction values and determining a set point for the wind turbine based on the plurality of corrected damage values.

### BACKGROUND

A system and method are disclosed for determining a life duration of a wind turbine. More specifically, a set point for the wind turbine is determined based on an estimate of damage developing in the wind turbine and a remaining life duration of the wind turbine.

Wind turbines include a rotor driven by the wind to produce mechanical energy. The mechanical energy is converted to electrical energy and provided to a power grid. The wind turbine includes a nacelle supporting the rotor and is positioned on a tower. The typical wind turbine components are designed to have a useful service life of about twenty to twenty five years. Fluctuations in environmental factors cause variations in loading pattern leading to premature component failure. These premature failures lead to unplanned service which is often a major portion of the operational cost to the wind turbine farm operator.

Unplanned servicing schedules and repairs reduce the productivity and increase the maintenance costs. The unplanned maintenance expenditure could be as high as five times the expenditure for the planned maintenance schedule. Maintenance costs for the wind turbines increase as time progresses and the probability of unscheduled maintenance would be higher. Reduction of incidents of unplanned maintenance would generate significant savings.

Therefore, techniques providing quantification of damage of the wind turbine at a given instance of time and determining a life duration of the wind turbine is required.

### BRIEF DESCRIPTION

In accordance with one aspect of the present technique a method is disclosed. The method includes receiving turbine data of a wind turbine having a plurality of persistent failure modes. The turbine data comprises installation data, operation data and historical data. The method also includes determining a plurality of damage values using a plurality of damage models based on the installation data and determining a plurality of correction values based on the operation data, and the historical data. The plurality of damage values are representative of severity of the plurality of persistent failure modes and the plurality of correction values are representative of severity of a plurality of sporadic failure modes. The method also includes determining a plurality of corrected damage values by modifying the plurality of damage values based on at least one of the plurality of correction values and determining a set point for the wind turbine based on the plurality of corrected damage values.

In accordance with one aspect of the present technique a system is disclosed. The system includes at least one processor module and a memory module communicatively coupled to a communications bus. The system further includes a data acquisition module receiving turbine data of a wind turbine having a plurality of persistent failure modes. The turbine data comprises installation data, operation data, historical data and environment data. The system further includes a damage estimation module communicatively coupled to the data acquisition module and configured to determine a damage values using a damage model based on the installation data. The system also includes a damage correction module communicatively coupled to the data acquisition module and configured to determine at least one correction value based on the operation data, and the historical data. The damage value is representative of severity of a persistent failure mode among the plurality of persistent failure modes and the correction value is representative of severity of a sporadic failure mode. The damage correction module is further configured to determine a corrected damage value by modifying the damage value based on the correction value based on the at least one correction value. The system also includes a damage projection module communicatively coupled to the damage estimation module and configured to determine a set point for the wind turbine based on the corrected damage value and determine a probabilistic operating profile corresponding to the persistent failure mode based on the environment data and the historical data. The damage projection module is further configured to determine a first projection value based on the probabilistic profile, wherein the first projection value is representative of severity of the persistent failure mode at a future time and determine a second projection value based on the correction value and the historical data, wherein the second projection value is representative of severity of the sporadic failure mode at the future time instant. The damage projection module is also configured to estimate a life duration of the wind turbine based on the probabilistic operating profile, the first projection value, and the second projection value. In the system, at least one of the data acquisition module, the damage estimation module, the damage correction module, and the damage projection module is stored in the memory module and executable by the at least one processor module.

In accordance with one aspect of the present technique a non-transitory computer readable medium having instructions to enable at least one processor module is disclosed. The instructions enable the at least one processor module to receive turbine data from a wind turbine having a plurality of persistent failure modes. The turbine data comprises installation data, operation data, historical data and environment data. The instructions enable the at least one processor module to determine a plurality of damage values using a plurality of damage models based on the installation data and a plurality of correction values based on the operation data, and the historical data. The plurality of damage values are representative of severity of the plurality of persistent failure modes and the plurality of correction values are representative of severity of a plurality of sporadic failure modes. The instructions further enable the at least one processor module to determine a plurality of corrected damage values by modifying the plurality of damage values based on at least one of the plurality of correction values and determine a set point for the wind turbine based on the plurality of corrected damage values. The instructions also enable the at least one processor module to determine a plurality of probabilistic operating profiles corresponding to the plurality of persistent failure modes based on the environment data, a first plurality of projection values based on the plurality of probabilistic operating profiles and a second plurality of projection values based on the plurality of correction values and the historical data. The first plurality of projection values are representative of the severity of the plurality of persistent failure modes at a future time instant and the second plurality of projection values are representative of the severity of the plurality of sporadic failure modes at the future time instant. The instructions also enable the at least one processor module to estimate a life duration of the wind turbine based on the first plurality of projection values and the second plurality of projection values.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of a system for determining life of a wind turbine in accordance with an exemplary embodiment;

FIG. 2 is a block diagram of system for determining life of the wind turbine in accordance with an exemplary embodiment;

FIG. 3 is a graph illustrating progression of damage values corresponding to two failure modes of a wind turbine in accordance with an exemplary embodiment;

FIG. 4 is a graph illustrating comparison of an actual damage value corresponding to a wind turbine with a predicted damage value at multiple instance of time in accordance with an exemplary embodiment;

FIG. 5 is a graph illustrating effect of sporadic failure mode on the damage value of a wind turbine in accordance with an exemplary embodiment;

FIG. 6 is a graph illustrating projection of a damage value into a future time instant in accordance with an exemplary embodiment; and

FIG. 7 is a flow chart of a method of determining a life of a wind turbine in accordance with an exemplary embodiment.

### DETAILED DESCRIPTION

Embodiments of methods and systems for determining life of a wind turbine are disclosed. Embodiments include receiving turbine data of a wind turbine, wherein the turbine data has installation data, operation data, environment data and historical data. The wind turbine exhibits a plurality of persistent failure modes and a plurality of sporadic failure modes. A plurality of damage values are determined using a plurality of damage models based on the installation data. A plurality of correction values are determined based on the operation data, and the historical data. The plurality of damage values are representative of severity of the plurality of persistent failure modes and the plurality of correction values are representative of the plurality of sporadic failure modes. A plurality of corrected damage values are determined based on the plurality of damage values and the plurality of correction values. A set point for the wind turbine is determined based on the plurality of corrected damage values. A plurality of probabilistic operating profiles corresponding to the plurality of persistent failure modes are determined based on the environment data and the turbine operation data. A first plurality of projection values are determined based on the plurality of probabilistic operating profiles. A second plurality of projection values are determined based on the plurality of correction values and the historical data. The first plurality of projection values and the second plurality of projection values are representative of severity of the plurality of persistent failure modes and the plurality of sporadic failure modes at a future time instant. A life duration of the wind turbine is estimated based on the plurality of probabilistic operating profiles, the first plurality of projection values and the second plurality of projection values.

The term ‘failure mode’ refers to a type of a wind turbine failure or a specific manner by which a wind turbine failure occurs. The term ‘persistent failure mode’ refers to predictable failure mode that persists as repeatable or otherwise able to discern during the operation of the wind turbine. For example, prognostics is able to determine failure modes that occur routinely based on diagnostic data and can predict failures. The term ‘sporadic failure mode’ refers to failure event that occur at a random time instant. The term ‘operating profile’ refers to a description of a mode of operation of the wind turbine such as a load condition. In one exemplary embodiment, the mode of operation corresponds to a range of power output. In another embodiment, the mode of operation corresponds to rate of change of wearing of a component of the wind turbine. In general, the wind turbine would operate in one of a plurality of modes of operation and each of the modes of operation is described by an operating profile. The parameters associated with the mode of operation at a future time instant would be associated with a probability distribution. The operating profile corresponding to a mode of operation at a future time instant would be probabilistic in nature and is referred herein as ‘probabilistic operating profile’. The term ‘set point’ refers in general to a load condition of the wind turbine. Specifically, the set point refers to a modified load condition to suit a scheduled maintenance and optimizing the cost of operation of the wind turbine. The term ‘recommended condition’ refers to range of operating conditions of a component or a system prescribed by the design. Operating conditions beyond the recommended conditions exceed the material limit or the system limit and accelerate the damage of the material or the system respectively.

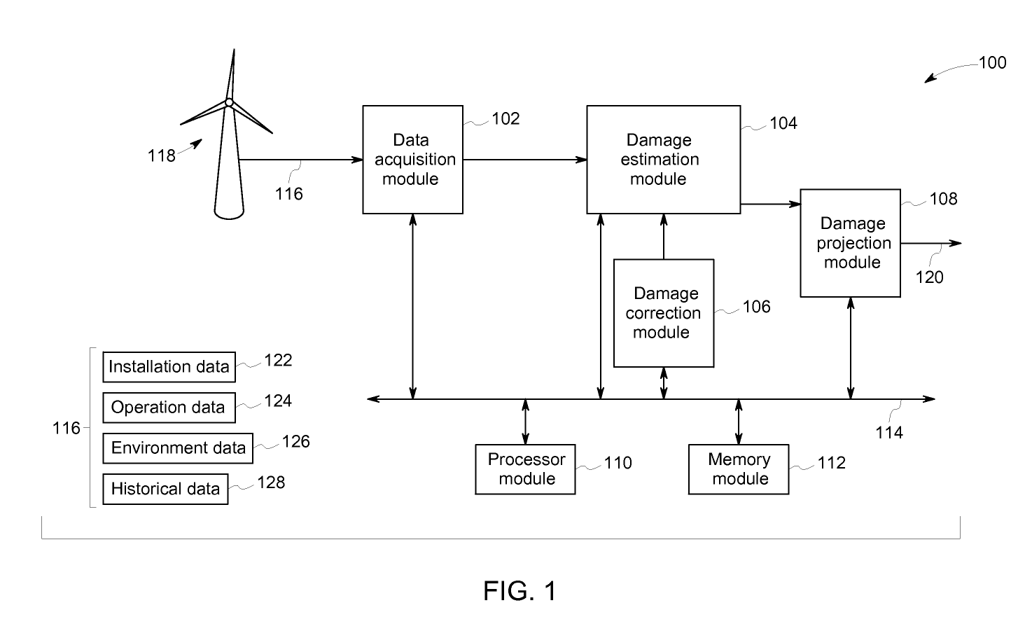

FIG. 1 is a diagrammatic illustration of a system 100 for determining life of a wind turbine in accordance with an exemplary embodiment. The system 100 includes a data acquisition system 102, a damage estimation module 104, a damage correction module 106, and a damage projection module 108. The system also includes at least one processor module 110 and a memory module 112 communicatively coupled to the modules 102, 104, 106, 108 via a communications bus 114. The system receives turbine data 116 from a wind turbine 118 and determines at least one of a set point and a life estimation 120 of the wind turbine.

In an exemplary embodiment, at least one of the modules 102, 104, 106, 108 is a standalone hardware module. In another exemplary embodiment, at least one of the modules 102, 104, 106, 108 is a software module stored in the memory module 112 and executable by the processor module 110. In other embodiments, the modules 102, 104, 106, 108 may be co-located or distributed in different geographical locations. One or more of the modules may be integrated into or executed by the at least one processor module 110 and stored in the memory module 112. In these embodiments, the modules 102, 104, 106, 108 are communicatively coupled by the communications bus 114 which may be wired, wireless or a combination thereof.

The data acquisition module 102 receives the turbine data 116 measured from the wind turbine 118. The turbine data 116 includes installation data 122, operation data 124, environment data 126 and historical data 128. The installation data 122 includes design specifications of components of the wind turbine 118, information about sensors used to acquire the turbine data. The installation data 122 also includes the structure and properties of components, operational principles of the wind turbine, mathematical models of the persistent failure modes of the wind turbine 118. The operation data 124 includes information obtained from maintenance reports, inspections, repairs and field failures. The operation data 124 includes observations and findings during operation of the wind turbine 118. The environment data 126 includes data common to the plurality of wind turbines in the wind farm such as wind speed, ambient turbulence intensity, wind shear, up flow angle, the location of wind turbine, and other environmental factors affecting the performance of the plurality of wind turbines. The historical data 128 refers to the data related to a category of wind turbines collected over a period of time and is stored in the memory module 112. Specifically, the historical data includes installation data of other similar wind farms located in other regions, operation data of other wind turbines over the part or whole of their life, and environment data of the past. The historical data may include any stored data related to the wind turbines under consideration or wind turbine data from other locations.

The turbine data 116 includes, but not limited to, supervisory control and data acquisition (SCADA) data, a plurality of pitch angles, a wind speed value, wind shear value, and ambient turbulence intensity. The data acquisition module is configured to perform signal conditioning of the received turbine data such as noise filtering and normalization of dynamic range of the received signals. The data acquisition module 102 is further configured to digitize the received turbine data via an analog to digital converter and store the digital data in the memory module 112.

The damage estimation module 104 is communicatively coupled to the data acquisition module 102 and configured to determine a damage value corresponding to a persistent failure mode based on the installation data. The damage value is representative of severity (or damage) of a predictable fault due to a persistent failure mode. The damage estimation module 104 determines a plurality of damage values corresponding to a plurality of persistent failure modes associated with the wind turbine. The plurality of persistent failure modes include, but not restricted to, fatigue, wear, and overload conditions. Each of the plurality of persistent failure modes is modelled based on the installation data and the historical data.

In an exemplary embodiment, the persistent failure mode corresponding to fatigue may be modelled based on load history, material properties and Wohler curves (a curve of stress magnitude ‘S’ as a function of logarithm of number of cycles to failure ‘N’—also termed as S−N curve) as input parameters and the model determines a Markov matrix for fatigue load as the output of the model. Rain flow method is used to determine the cycle counts and Miners rule model is used to determine the fraction of life consumed due to the exposure of the cycle counts.

In another exemplary embodiment, a persistent failure mode corresponding to overload is determined based on a model receiving load history and material properties as inputs and determining number of allowable overload peaks beyond design limit as an output parameter. In another embodiment, a persistent failure mode corresponding to wear is determined based on a model receiving load history and material wear constant as input parameters and total cycles accumulated at a given load as an output parameter. The damage value is determined based on the accumulated loss of material determined based on the output parameter.

The damage correction module 106 is communicatively coupled to the data acquisition module 102 and configured to determine a correction value based on the operation data and the historical data in order to generate a corrected damage value. The correction value represents modifications required to the severity of the predictable faults during operation of the wind turbine. The correction value also includes accelerated damage due to sporadic failure modes. The term ‘sporadic failure mode’ is used to refer failure modes associated with unpredictable events. The sporadic failure modes include, but not limited to, loose bolt, assembly misalignment, inherent defects, and starved lubrication. It should be noted herein that the sporadic failure modes affect the plurality of persistent failure modes in varying degree.

As an example, the loose bolt failure mode aggravates fatigue failures. In another example, the assembly misalignment failure mode influences the fatigue and wear failure modes. In another example, starved lubrication failure mode affects the wear failure mode. Empirical methods may be employed upon detection of the sporadic failure modes to determine a plurality of correction values. The plurality of correction values include contributions from a number of sporadic failure modes. In one embodiment, the correction value is numerical value greater than one used as a multiplying factor for a damage value. In another embodiment, the correction value is a numerical value greater than zero added to the damage value to generate the corrected damage value.

The damage projection module 108 is communicatively coupled to damage correction module 106 and configured to determine a probabilistic operating profile corresponding to each of the plurality of persistent failure modes to generate a plurality of probabilistic operating profiles. The plurality of probabilistic profiles are determined based on the environment data and the historical data. The plurality of probabilistic profiles are used to project the plurality of damage values to a future time instant generating a first plurality of projection values. The damage projection module 108 is further configured to determine a second plurality of projection values corresponding to the plurality of sporadic failure modes. The second plurality of projection values are estimates of the plurality of correction values at the future instant of time. The damage projection module 108 is configured to estimate a life duration of the wind turbine based on the probabilistic operating profile, the first plurality of projection values and the second plurality of projection values. The damage projection module 108 is also configured to determine a set point for the wind turbine based on the corrected damage value received from the damage correction module 106.

The processor module 110 includes at least one arithmetic logic unit, a microprocessor, a general purpose controller or a processor array to perform the desired computations or run the computer program. In one embodiment, the functionality of the processor module 110 may be limited to acquire turbine data. In another embodiment, the functionality of the processor module 110 may be limited to determining a damage value corresponding to a persistent failure mode. In another embodiment, the functionality of the processor module 110 is limited to generating the correction value corresponding to a sporadic failure mode. In some exemplary embodiments, functionality of the at least one processor module would include one or more of the functions of the data acquisition module 102, the damage estimation module 104, the damage correction module 106, and the damage projection module 108. While the processor module 110 is shown as a single unit, there can be more than one processor modules cooperatively operating to perform the functionalities offered by one or more of the modules 102, 104, 106, 108.

The memory module 112 may be a non-transitory storage medium. For example, the memory module 112 may be a dynamic random access memory (DRAM) device, a static random access memory (SRAM) device, flash memory or other memory devices. In one embodiment, the memory module 112 may include a non-volatile memory or similar permanent storage device, media such as a hard disk drive, a floppy disk drive, a compact disc read only memory (CD-ROM) device, a digital versatile disc read only memory (DVD-ROM) device, a digital versatile disc random access memory (DVD-RAM) device, a digital versatile disc rewritable (DVD-RW) device, a flash memory device, or other non-volatile storage devices. In one specific embodiment, a non-transitory computer readable medium may be encoded with a program to instruct the processor module 110 to determine the life duration of the wind turbine.

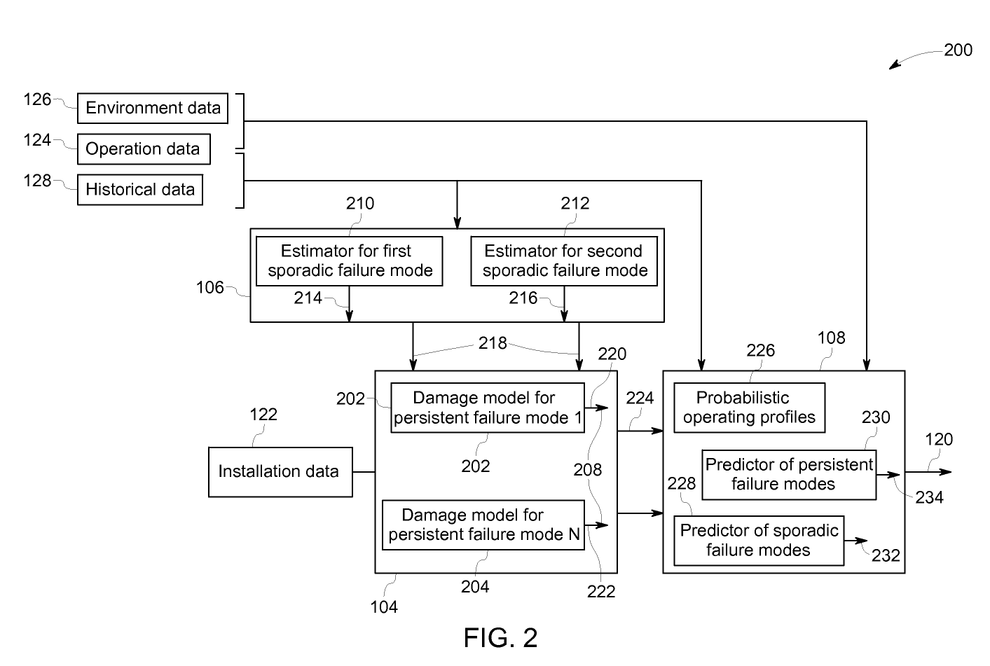

FIG. 2 is a block diagram 200 of system for determining life of the wind turbine in accordance with an exemplary embodiment. The damage estimation module 104 of FIG. 1 includes a plurality of damage models 202, 204 for determining a plurality of damage values 208 corresponding to a plurality of persistent failure modes. The damage model 202 corresponds to a first failure mode generating a first damage value 220. The damage model 204 corresponds to a second failure mode generating a second damage value 222. In another embodiment, each of the plurality of damage values 208 may be derived from combining one or more of the first damage value 220 and the second damage value 222. It should be noted herein that the two damage models 202, 204 are not limiting the system of FIG. 2 and in general additional damage models corresponding to other persistent failure modes may be included. A plurality of damage models corresponding to the plurality of persistent failure modes generate the plurality of damage values 208. The term ‘damage model’ used herein refers to at least one of a mathematical equation, an algorithm, and a technique used for determining a damage value corresponding to a persistent failure mode.

In one example, three failure modes are considered and corresponding damage values are determined. In this example, the first failure mode corresponds to the fatigue failure condition, the second failure mode corresponds to the wear failure condition and the third failure mode corresponds to the overload failure condition. The plurality of damage values may also include damage due to gear faults, bearing defects, and structural damages. In one embodiment, the plurality of damage values 208 may be combined to generate an equivalent damage value corresponding to the wind turbine. In another embodiment, the plurality of damage values 208 may be modified individually with a corresponding correction value as explained in a subsequent paragraph.

The damage correction module 106 of FIG. 1 determines a plurality of correction values 218 corresponding to a plurality of sporadic failure modes. The plurality of sporadic failure modes include but not limited to loosening bolt, assembly misalignment, inherent defects, and starved lubrication condition. The plurality of correction values are identified based on the operation data 124. The plurality of correction values 218 are representative of severity of the sporadic failure modes. A first correction value 214 corresponding to a first sporadic failure mode is determined by a first estimator 210. A second correction value 216 corresponding to a second sporadic failure mode is determined by a second estimator 212. The plurality of correction values 218 include the first correction value 214 and the second correction value 216. In an alternate embodiment, each of the plurality of the correction values 218 is derived based on one or more of the first correction value 214 and the second correction value 216. The first correction value 214 and the second correction value 216 may be combined using operations such as addition, multiplication and scaling.

Although only two estimators are shown in the damage correction module 106, it should not be construed as a limitation of the system disclosed herein and in general more number of estimators may be used. In one embodiment, the plurality of correction values 218 corresponding to severity of sporadic failure modes are determined. In one example, the plurality of correction values 218 may be represented by a real number between zero and one with lower magnitudes of severity indicating higher weightage for the sporadic failure mode. In one embodiment, a product of the plurality of correction values 218 is generated to determine a single correction value due to all sporadic failure modes. The single correction value is applied to the plurality of damage values 220 222 and an equivalent corrected damage value is generated. In another embodiment, the plurality of correction values 218 are used to modify the corresponding plurality of damage values 220, 222 to generate a plurality of corrected damage values 224.

In one exemplary embodiment, the historical data may be used to generate a remote monitoring and diagnostics (RMD) repository of signatures and associated rules. The operational data generated during regular maintenance may be used to modify and update the RMD repository. Correlation of measured data or predicted data with the signatures of the repository provides an estimate of damage values and further determines the life of the components of the wind turbine or wind turbine as a whole. The RMD repository includes signatures and rules required to determine damage values corresponding to persistent failure modes, and sporadic failure modes at present instance of time and a time instant in the future.

The damage projection module 108 of FIG. 1 receives the environment data 126 and determines at least one probabilistic operating profile 226 corresponding to at least one of the plurality of persistent failure modes, based on the environment data. In an alternate embodiment, a probabilistic profile is determined for at least one of the plurality of corrected damage values 224. A first plurality of projection values 234 is determined by projecting the plurality of corrected damage values 224 based on the plurality of probabilistic operating profiles. The first plurality of projection values 234 represent severity of the plurality of persistent failure modes at a future time instant. A second plurality of projection values 232 are determined based on the plurality of correction values. The second plurality of projection values are representative of severity of the plurality of sporadic failure modes at the future time instant. The second plurality of projection values 232 are determined using data segmentation techniques applied to the historical data. The first plurality of projection values 234 are determined by a predictor of persistent failure modes 230. The second plurality of projection values 232 are determined by a predictor of sporadic failure modes 228.

The plurality of probabilistic operating profiles are determined using statistical models of one or more parameters of the turbine data. In one exemplary embodiment, the wind speed of the environment data is modelled as a Weibull distribution given by:

$$\begin{matrix}f ( x ; λ , k ) = \frac{k}{λ} {( \frac{x}{λ} )}^{k - 1} {e}^{- {( \frac{x}{λ} )}^{k}} & if x \geq 0 \\ = 0 & if x < 0\end{matrix} \qquad ( 1 )$$

where, x is representative of wind speed, k>0 is the shape parameter and λ>0 is the scale parameter of the distribution. The distribution of Eq. (1) is skewed. The Weibull distribution is equivalent to Exponential distribution for k=1 and Rayleigh distribution for k=2. In some embodiments, the wind data is modelled by a Rayleigh distribution with lesser accuracy.

In one embodiment, an equivalent projected damage value may be determined based on the first plurality of projection values and the second plurality of projection values. In an exemplary embodiment, the first plurality of projection values are modified based on the plurality of second plurality of projection values. The modified values of the first plurality of projection values are linearly combined with a plurality of weighing factors. The weighing factors in one example are provided by an operator based on the relative contribution of the plurality of persistent failure modes to the equivalent projected damage. A life duration of the wind turbine is determined based on the equivalent projected damage value. In alternative embodiments, the first plurality of projection values 234 and the second plurality of projection values 232 are used in determining the life duration of the wind turbine.

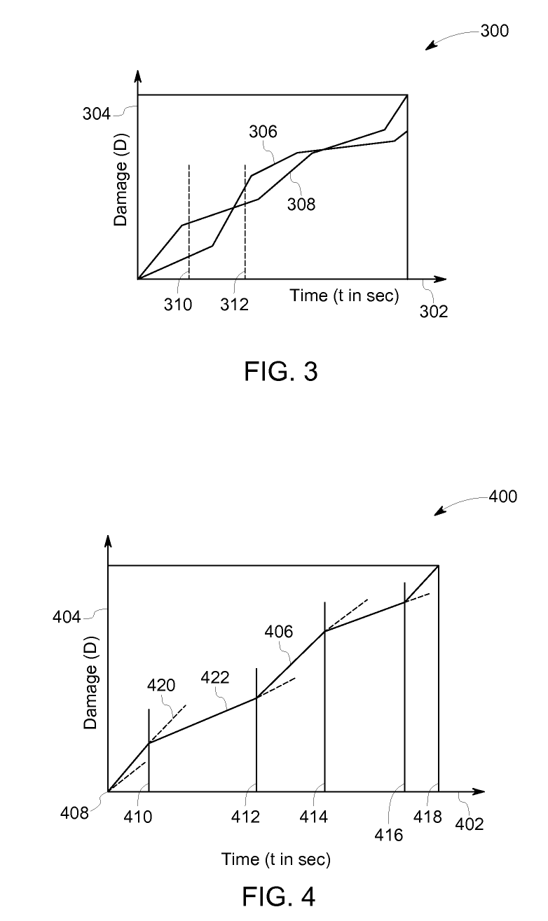

FIG. 3 is a graph 300 illustrating progression of damage values corresponding to two persistent failure modes of a wind turbine in accordance with an exemplary embodiment. The graph 300 has an x-axis 302 of time in seconds and a y-axis 304 representative of damage values. The graph 300 includes two curves 306,308 representing progression of damage value corresponding to a first failure mode and a second failure mode respectively. Two time instants 310, 312 are indicated on the x-axis has 302. At a first time instant 310, the damage value corresponding to the curve 308 has a larger value compared to the damage value corresponding to the curve 306. A life duration of the wind turbine estimated based on a leading damage value would consider the second failure mode represented by the curve 308. At a second time instant 312, the damage value corresponding to the curve 308 has a smaller value compared to the damage value corresponding to the curve 306. A life duration of the wind turbine estimated based on a leading damage value would consider the first failure mode represented by the curve 306. A life duration of the wind turbine determined by various embodiments disclosed herein would consider damage values from both the first failure mode and the second failure mode. In general, the technique of determining the life duration of the wind turbine would consider damage values corresponding to the plurality of persistent failure modes.

FIG. 4 is a graph 400 illustrating comparison of an actual damage value corresponding to a wind turbine with a predicted damage value at multiple instance of time in accordance with an exemplary embodiment. The graph 400 has an x-axis 402 representative of time in seconds and a y-axis 404 representative of damage values of a persistent failure mode. The graph 400 includes a curve 406 of the persistent failure mode. A plurality of time instants 408, 410, 412, 414, 416, 418 are represented on the x-axis 402. At each of the time instants, the actual damage value deviates from a predicted damage value estimated by a model corresponding to the persistent failure mode. For example, at time instant 410, the actual failure mode is represented by solid line 422 and modelled failure mode is represented by a dashed line 420. As explained in previous paragraphs, use of inspection data would correct the path of the persistent failure mode from the dashed line 420 to the solid line 422.

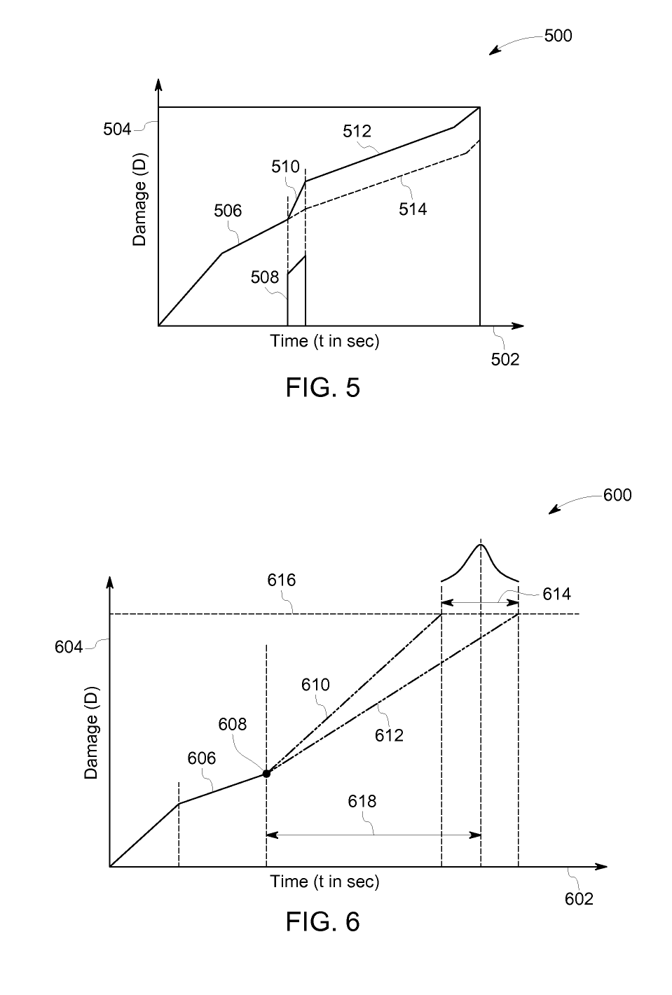

FIG. 5 is a graph 500 illustrating effect of sporadic failure mode on the damage value of a wind turbine in accordance with an exemplary embodiment. The graph 500 includes an x-axis 502 representative of time in seconds and a y-axis 504 representative of damage values. The graph 500 includes a curve 506 representative of a persistent failure mode. The curve 506 exhibits a sharp variation in the region 510 due to an sporadic failure mode 508. The uncorrected persistent failure mode after the occurrence of the sporadic failure mode 508 is represented by a dashed line curve 514. The corrected persistent failure mode after the occurrence of the sporadic failure mode 508 is represented by a solid line curve 512. Exemplary embodiments disclosed herein would generate correction values to modify the damage values to points along the curve 512 from the corresponding points along the curve 514.

FIG. 6 is a graph 600 illustrating projection of a damage value into a future time instant in accordance with an exemplary embodiment. The graph 600 includes an x-axis 602 representative of time and a y-axis 604 representative of damage values. The graph 600 also includes a curve 606 representative of a persistent failure mode. A damage value corresponding to present instant of time is represented by a point 608 on the curve 606. The dotted lines 610 and 612 are representative of projections of the curve 606 from the point 608 in time. The projection in time is based on the probabilistic operating profile as explained in previous paragraphs. A line 616 corresponding to damage value one represents a failure condition and intersection of curve representative of the persistent failure mode provides the time to failure (TTF) estimation. The duration 614 is representative of uncertainty of TTF at a future instant of time and is governed by a TTF distribution. The mean value of the distribution may be used to determine life duration 618 of the turbine from present instant of time.

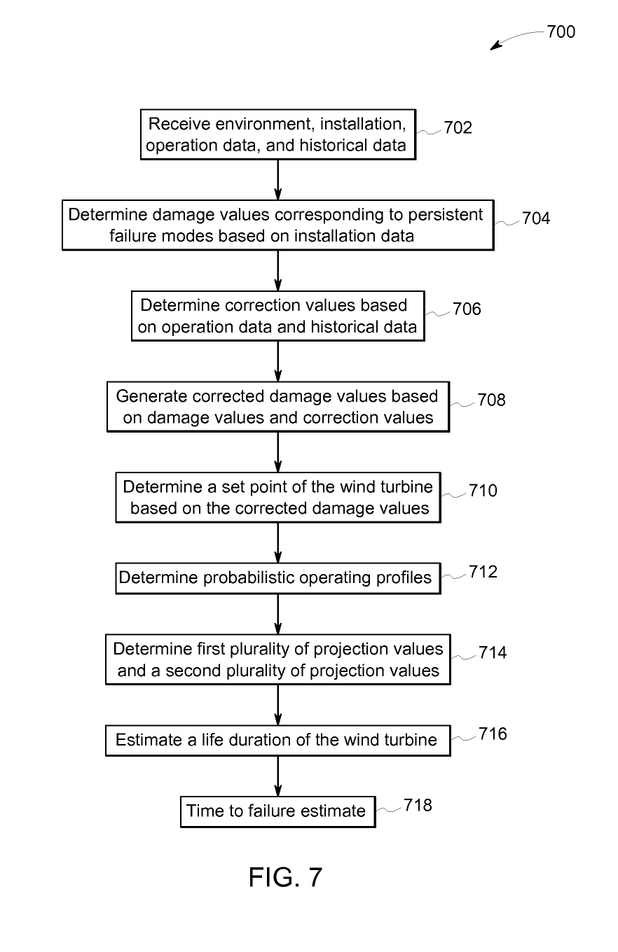

FIG. 7 is a flow chart 700 of a method of determining a life of a wind turbine in accordance with an exemplary embodiment. The method includes receiving turbine data comprising installation data, operation data, environment data and historical data 702. The receiving of the data 702 also includes receiving at least one of SCADA data, a plurality of pitch angles, a wind speed value, wind shear value, and ambient turbulence intensity. A plurality of damage values corresponding to a plurality of persistent failure modes are determined based on the installation data 704. In exemplary embodiments disclosed herein, the plurality of damage values include, but not limited to, damage due to gear faults, bearing defects, structural damages, and lubrication failure.

A plurality of correction values corresponding to the plurality of damage values are determined based on the operation data and the historic data 706. In one exemplary embodiment, the plurality of correction values include corrections due to sporadic failure modes and corrections to the progression of persistent failure modes determined based on the data obtained during maintenance schedule. The contribution from a sporadic failure mode is a damage correction value determined based on the operation data. In one embodiment, the damage correction value is determined based on a site-Weibulls distribution. In some embodiments, the plurality of correction values are determined based on contributions from field loading within recommended conditions and beyond recommended conditions. In another embodiment, the damage correction value is determined by correlating remote monitoring diagnostics data with the historical data. Specifically, determining the plurality of correction values includes determining a new signature based on the operation data. The new signature is compared with a plurality of stored signatures available in the historical data and a closely matching stored signature is identified. The new signature is correlated with the closely matched stored signature to generate a coefficient of correlation. The coefficient of correlation is representative of damage correction value.

The plurality of correction values are used to modify the plurality of damage values to determine a plurality of corrected damage values 708. An optimal operation for the wind turbine, in the form of a set point, may be determined based on the plurality of corrected damage values 710. The term optimal operation refers to a modified load condition to suit a scheduled maintenance and optimizing the cost of operation of the wind turbine. A plurality of probabilistic operating profiles corresponding to the plurality of persistent failure modes are determined based on the environment data 712. It should also be noted that turbine data other than the environment data may also be used to determine the plurality of probabilistic operating profiles.

The plurality of corrected damage values may be projected in time based on the corresponding probabilistic operating profiles to determine a first plurality of projection values. A second plurality of projection values corresponding to the plurality of sporadic failure modes may be determined based on a data segmentation technique. The data segmentation technique includes assigning a probability value to each of the sporadic failure mode based on the historical data 714. In one embodiment, the first plurality of projection values and the second plurality of projection values are combined to determine an equivalent projected damage value. Such an equivalent projected damage value may be determined at each future instant of time. The equivalent projected damage value may be compared with a turbine failure threshold value. When the equivalent projected damage value exceeds the turbine failure threshold value, a corresponding time instant may be recorded. The duration between the present time instant and the time instant corresponding to a damage value equal to the turbine failure threshold value is used to determine a life duration of the wind turbine 716. The life duration of the wind turbine provides a time to failure estimate 718.

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the specification may include only some of the described embodiments. Accordingly, the specification is not to be seen as limited by the foregoing description, but is only limited by the scope of the appended claims.

1. A method, comprising:
receiving turbine data of a wind turbine having a plurality of persistent failure modes, wherein the turbine data comprises installation data, operation data and historical data;
determining a plurality of damage values using a plurality of damage models based on the installation data, wherein the plurality of damage values are representative of severity of the plurality of persistent failure modes;
determining a plurality of correction values based on the operation data, and the historical data, wherein the plurality of correction values are representative of severity of a plurality of sporadic failure modes;
determining a plurality of corrected damage values by modifying the plurality of damage values based on at least one of the plurality of correction values; and
determining a set point for the wind turbine based on the plurality of corrected damage values.

2. The method of claim 1, further comprising:
receiving the turbine data comprising environment data;
determining a plurality of probabilistic operating profiles corresponding to the plurality of persistent failure modes based on the environment data and the historical data;
determining a first plurality of projection values based on the plurality of probabilistic operating profiles, wherein the first plurality of projection values are representative of the severity of the plurality of persistent failure modes at a future time instant;
determining a second plurality of projection values based on the plurality of correction values and the historical data, wherein the second plurality of projection values are representative of the severity of the plurality of sporadic failure modes at the future time instant; and
estimating a life duration of the wind turbine based on the first plurality of projection values and the second plurality of projection values.

3. The method of claim 2, wherein receiving the turbine data comprises receiving at least one of supervisory control and data acquisition data, a plurality of pitch angles, a wind speed value, wind shear value, and an ambient turbulence intensity.

4. The method of claim 1, wherein the plurality of damage values comprises damage due to at least one of gear faults, bearing defects, structural damages, and lubrication failure.

5. The method of claim 1, wherein determining the plurality of correction values comprises determining a damage correction value contributed by a persistent failure mode among the plurality of persistent failure modes, wherein the damage correction value is based on the operation data.

6. The method of claim 5, wherein determining the damage correction value is based on a site-Weibulls distribution.

7. The method of claim 5, wherein determining the damage correction value comprises correlating remote monitoring diagnostics data with the historical data.

8. The method of claim 1, wherein determining the plurality of correction values comprises determining a new signature based on the operation data.

9. The method of claim 1, wherein determining the plurality of correction values comprises determining contributions from field loading within recommended conditions and beyond recommended conditions.

10. A system, comprising:
at least one processor module and a memory module communicatively coupled to a communications bus;
a data acquisition module receiving turbine data of a wind turbine having a plurality of persistent failure modes, wherein the turbine data comprises installation data, operation data, historical data and environment data;
a damage estimation module communicatively coupled to the data acquisition module and configured to determine a damage values using a damage model based on the installation data, wherein the damage value is representative of severity of a persistent failure mode among the plurality of persistent failure modes;
a damage correction module communicatively coupled to the data acquisition module and configured to:
determine at least one correction value based on the operation data, and the historical data, wherein the correction value is representative of severity of a sporadic failure mode; and
determine a corrected damage value by modifying the damage value based on the correction value based on the at least one correction value;
a damage projection module communicatively coupled to the damage estimation module and configured to:
determine a set point for the wind turbine based on the corrected damage value;
determine a probabilistic operating profile corresponding to the persistent failure mode based on the environment data and the historical data;
determine a first projection value based on the probabilistic profile, wherein the first projection value is representative of severity of the persistent failure mode at a future time;
determine a second projection value based on the correction value and the historical data, wherein the second projection value is representative of severity of the sporadic failure mode at the future time instant; and
estimate a life duration of the wind turbine based on the probabilistic operating profile, the first projection value, and the second projection value;
wherein, at least one of the data acquisition module, the damage estimation module, the damage correction module, and the damage projection module is stored in the memory module and executable by the at least one processor module.

11. The system of claim 10, wherein the turbine data comprises supervisory control and data acquisition data, a plurality of pitch angles, a wind speed value, wind shear, and an ambient turbulence intensity.

12. The system of claim 10, wherein the damage estimation module is further configured to determine a plurality of damage values corresponding to a plurality of persistent failure modes comprising gear damages, bearing defects, structural damages, and lubrication failure.

13. The system of claim 10, wherein the damage correction module is further configured to determine a damage correction value contributed by a persistent failure mode among the plurality of persistent failure modes, wherein the damage correction value is based on the operation data.

14. The system of claim 13, wherein the damage correction module is configured to determine the damage correction value based on the site-Weibulls distribution.

15. The system of claim 13, wherein the damage correction module is configured to determine the damage correction value by correlating remote monitoring diagnostics data with the historical data.

16. The system of claim 15, wherein the damage correction module is further configured to determine a new signature based on the operation data.

17. The system of claim 10, wherein the damage correction module is further configured to determine contributions from field loading within recommended conditions and beyond recommended conditions.

18. A non-transitory computer readable medium having instructions to enable at least one processor module to:
receive turbine data from a wind turbine having a plurality of persistent failure modes, wherein the turbine data comprises installation data, operation data, historical data and environment data;
determine a plurality of damage values using a plurality of damage models based on the installation data, wherein the plurality of damage values are representative of severity of the plurality of persistent failure modes;
determine a plurality of correction values based on the operation data, and the historical data, wherein the plurality of correction values are representative of severity of a plurality of sporadic failure modes;
determine a plurality of corrected damage values by modifying the plurality of damage values based on at least one of the plurality of correction values; and
determine a set point for the wind turbine based on the plurality of corrected damage values;
determine a plurality of probabilistic operating profiles corresponding to the plurality of persistent failure modes based on the environment data;
determine a first plurality of projection values based on the plurality of probabilistic operating profiles, wherein the first plurality of projection values are representative of the severity of the plurality of persistent failure modes at a future time instant;
determine a second plurality of projection values based on the plurality of correction values and the historical data, wherein the second plurality of projection values are representative of the severity of the plurality of sporadic failure modes at the future time instant; and
estimate a life duration of the wind turbine based on the first plurality of projection values and the second plurality of projection values.
